(19) United States
(12) Patent Application Publication
(10) Pub. No.: US 2013/0124491 A1
(43) Pub. Date: May 16, 2013

(54) Efficient Pipelined Binary Search

(71) Applicants: Gerald Pepper, Thousand Oaks, CA (US); Sean Huang, Van Nuys, CA (US)

(72) Inventors: Gerald Pepper, Thousand Oaks, CA (US); Sean Huang, Van Nuys, CA (US)

(21) Appl. No.: 13/294,981

(22) Filed: Nov. 11, 2011

(51) Int. Cl. G06F 17/30

(52) U.S. Cl. 707/706; 707/758; 707/E17.108

(57) ABSTRACT

An apparatus and machine readable storage medium for performing a binary search of an ordered list containing 2^{N} values, where N is an integer greater than one. The apparatus may include a pipeline having N stages numbered 1 to N in sequence. Stage M of the pipeline, where M is in integer from 1 to N, may include a memory storing 2^{M-1} values from the ordered list, a comparator to compare the key to a value read from the memory based on comparison results from previous stages in the pipeline, and a result storage register to store a comparison result from the comparator and the comparison results from the previous stages in the pipeline.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to pipelined hardware for performing a binary search of an ordered list of data items.

2. Description of the Related Art

Searching an ordered list of data items is a common task. For example, a telephone directory is a list of subscribers' names in alphabetical order. A typical manual search in a telephone directory may be performed by opening the directory to an estimated position, comparing a target name with the names in the directory, and then making a new estimate of the position of the target name.

A binary search is a rigorous search algorithm to find the position of a specific value, called the search “key”, in an ordered list or array of data values. At the first step in a binary search, the key is compared to the middle value in the array. Assuming the key and the middle value are not equal, the result of the comparison indicates in which half of the list the key value is located. If the key is smaller than the middle value, the key may be found in the lower half of the array (the half having values smaller than the middle value). If the key is larger than the middle value, the key may be found in the upper half of the array (the half having values larger than the middle value). The process is then repeated, comparing the key to the middle value in the appropriate half of the array. At each iteration, the field of search is reduced by half. After a suitable number of iterations, the field of the search will be reduced to a single final value, which will either equal the key or will be, for example, the largest value in the array that does not exceed the key. In either case, the output of the search is the location or index of the final value within the array. This index may commonly be used to retrieve an associated data item from a different array.

The number of comparisons that are performed in a binary search is a logarithmic function of the number data items in the sorted list. For example, if a sorted list contains 2^{N} items, where N is a positive integer, a binary search may be completed with N comparisons.

Binary searches are commonly performed by a processor using an iterative software algorithm. However, in some applications, such as routing data items within a communications network or generating traffic to test a communications network, high speed repetitive binary searching may be required.

### DESCRIPTION OF THE DRAWINGS

FIG. 1 is a graphical depiction of an ordered list.

FIG. 2 is a block diagram of an exemplary pipelined binary search engine.

FIG. 3 is a timing diagram.

FIG. 4 is a block diagram of another exemplary pipelined binary search engine.

FIG. 5 is a graphical depiction of another ordered list.

FIG. 6 is a block diagram of another exemplary pipelined binary search engine.

FIG. 7 is a block diagram of a generalized pipelined binary search engine.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

Description of Apparatus

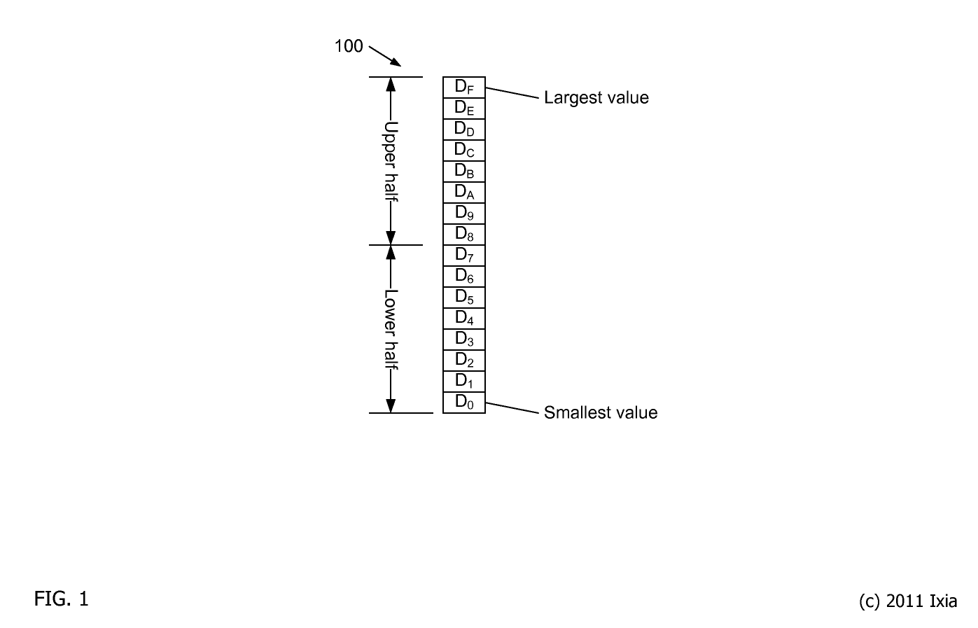

FIG. 1 is a graphical representation of an exemplary ordered list 100, which is necessary background information for understanding subsequent descriptions. The ordered list 100 contains sixteen values, identified as D₀ to D_{F} using hexadecimal notation. D₀ is the smallest value in the ordered list and D_{F} is the largest value. Each of the other values in the list is larger than the preceding value and smaller than the succeeding value. An ordered list containing sixteen values was chosen for ease of description. An ordered list may contain substantially more than sixteen values.

The ordered list may be divided into an upper half, and a lower half, each containing eight values. D₈ is the smallest value in the upper half of the ordered list 100, and D₇ is the largest value in the lower half of the ordered list 100. The significance of these values will be discussed subsequently.

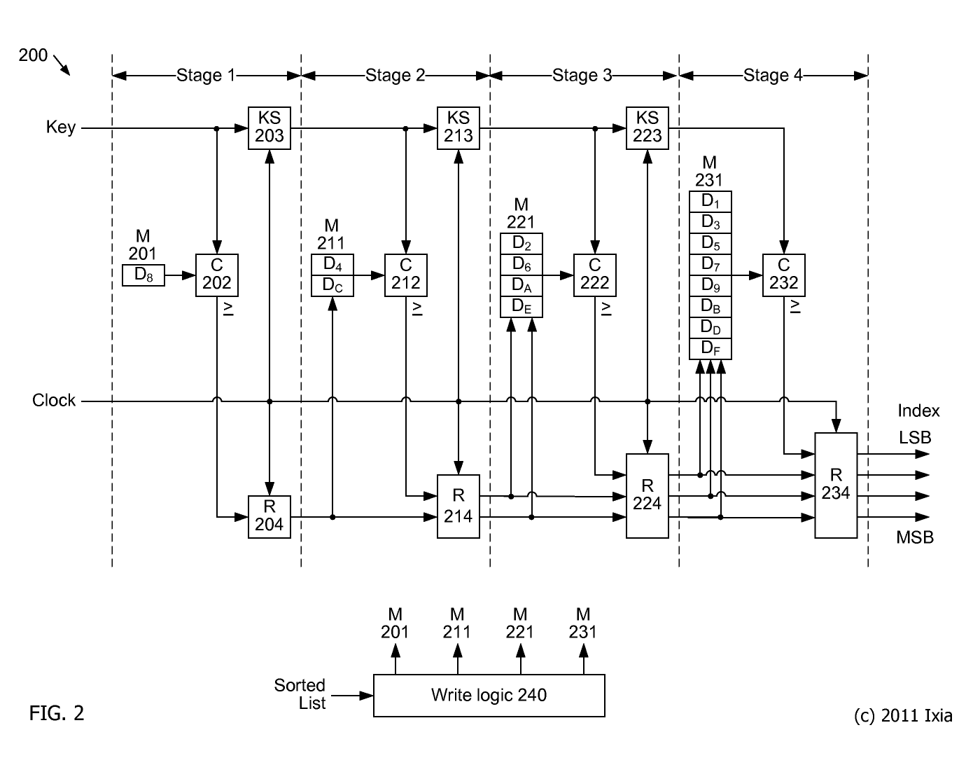

FIG. 2 is a block diagram of a pipelined binary search engine 200 configured to perform a binary search of the ordered list 100 of FIG. 1. The pipelined binary search engine 200 includes four stages, identified as stage 1 through stage 4. Each stage includes a memory M (201, 211, 221, 231, respectively), a comparator C (202, 212, 222, 232, respectively), a key storage register KS (203, 213, 223, respectively), and a result register R (204, 214, 224, 234, respectively).

Within this description, the term “engine” means a collection of hardware that performs the described functions. An engine may typically be designed using a hardware description language (HDL) that defines the engine primarily in functional terms. The HDL design may be verified using an HDL simulation tool. The verified HDL design may then be converted into a gate netlist or other physical description of the engine in a process commonly termed “synthesis”. The synthesis may be performed automatically using a synthesis tool. The gate netlist or other physical description may be further converted into programming code for implementing the engine in a programmable integrated circuit device such as a field programmable gate array (FPGA), a programmable logic device (PLD), or a programmable logic array (PLA). The gate netlist or other physical description may be converted into process instructions and masks for fabricating the engine within an application specific integrated circuit (ASIC).

An engine may be implemented using all or portions of one or more programmable integrated circuit devices. In this case, the programming code may be stored on a machine-readable storage medium. The stored programming code may subsequently be used to configure the programmable integrated circuit device or devices to include the desired engine. Suitable storage media include, for example, magnetic media such as hard disks, floppy disks and tape; optical media such as compact disks (CD-ROM and CD-RW) and digital versatile disks (DVD and DVD±RW); flash memory cards; and other storage media. As used herein, the term “storage medium” means a physical device for storing data and does not include transitory media such as propagating signals.

Each of the key storage registers KS (203, 213, 223, 233) and the result registers R (204, 214, 224, 234) may be one or more flips-flops, a register, a latch, or other circuit that stores input data in accordance with a clock signal. A common clock signal may be provided to all of the key storage registers and the results registers.

Each of the memories M (201, 211, 221, 231) may be digital circuits that allow storage and retrieval of one or more digital values. For example, memory 201 may store a single digital value in a latch or register. Memory 211 may include two registers to store two digital values and a multiplexer to allow retrieval of a selected one of the values. Similarly, memory 231 may be implemented with eight registers and a multiplexer or an eight-word random access memory.

Write logic 240 controls storing the elements of a sorted list of values into the memories 201, 211, 221, 231. The value or values stored in each memory are noted with reference to the sorted list shown in FIG. 1.

First considering stage 1 of the pipelined binary search engine 200, the value D₈ is stored in the stage 1 memory 201. Referring back to FIG. 1, it can be seen that half of the values in the sorted list 100 are less than the value D₈, and half of the values in the sorted list 100 are greater than or equal to the value D₈. In stage 1 of the binary search engine 200, a key is compared with the value D₈ (retrieved from memory 201) by the stage 1 comparator 202. The result from the comparator 202 is a single bit which is a logic zero when the key is less than the value D₈, or logic one when the key is greater than or equal to the value D₈. Thus the result from the comparator 202 indicates whether the key falls within the lower half or the upper half of the sorted list 100. The result from the comparator 202 is stored in the stage 1 result register 204. Simultaneously, the key is stored in the stage 1 key storage register 203.

Next considering stage 2 of the pipelined binary search engine 200, the values D₄ and D_{C} are stored in the stage 2 memory 211. Referring back to FIG. 1, it can be seen that the values D₄ and D_{C} are at the mid-points of the lower half and the upper half, respectively, of the ordered list 100. Either D₄ or D_{C} is read from the memory 211 based on the result stored in the stage 1 result register 204. The read value is compared with the key from the stage 1 key storage register 203 by the stage 2 comparator 212. The result from the stage 2 comparator 212, as well as the result from the stage 1 result register 204, are stored in the stage 2 result register 214. The results stored in the stage 2 result register identify a quarter of the ordered list 100 in which the key value may be found.

Stages 3 and 4 operate similarly to stage 2 of the pipelined binary search engine 100. Each stage has twice as much memory as the preceding stage, and each stage reads a single value from its respective memory using the collective results of the comparisons performed in the previous stages. Each stage compares the value read from its memory to the key, and stores the result of the comparison along with the results from the previous stages in its respective results register.

At the conclusion of stage 4 of the pipelined binary search engine 100, the 4-bit value stored in the stage 4 result register 234 is an index that indicates the position in the ordered list that holds the smallest value from the ordered list that equals or exceeds the key value. Note that, when the ordered list contains 2^{N} elements and the key value has K bits, where K>N, the key value is not necessarily equal to any value within the ordered list.

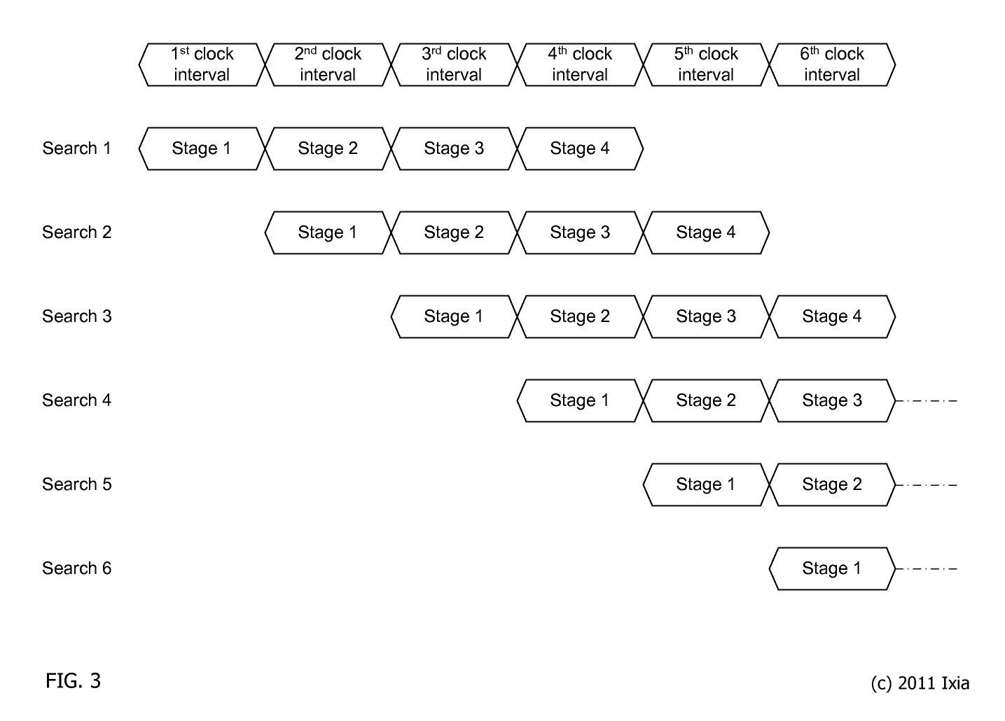

FIG. 3 is a timing diagram of the operation of the pipelined binary search engine 200 of FIG. 2. The operations (retrieving a selected value from memory, comparing the retrieved value to the key, storing the result of the comparison in the result register) at the successive stages of the pipelined binary search engine 200 may be performed during successive clock intervals. Each clock interval may be an interval between successive rising edges or successive falling edges of the clock signal provided to the storage registers KS (203, 213, 223, 233) and the result registers R (204, 214, 224, 234) in the pipelined binary search engine 200.

For example, a first search (Search 1) based on a first key may be initiated during a first clock interval. At the end of the first clock interval, the result of the stage 1 comparison may be stored in the stage 1 result register 204 and the first key may be stored in the stage 1 key storage register 203. At the end of the second clock interval, the result of the stage 1 and stage 2 comparisons may be stored in the stage 2 result register 214 and the first key may be stored in the stage 2 key storage register 213. At the end of the 3rd clock interval, the results of the stage 1, 2, and 3 comparisons may be stored in the stage 3 result register 224 and the first key may be stored in the stage 3 key storage register 223. At the end of the 4th clock interval, the result of the stage 1-4 comparisons, which is the index output from the pipelined binary search engine, may be stored in the stage 4 result register 234 and the first key may be optionally stored in a stage 4 key storage register (not shown). Note that storing the first key in a stage 4 key storage register is not necessary for the operation of the pipelined binary search engine, and a stage 4 key storage register may be included only if required for some other purpose.

Since the stage 1 hardware is not utilized by the first search after the first clock interval, a second search (Search 2) based on a second key may be initiated during the second clock interval and completed during the 5^{th} clock interval. Similarly, Searches 3-6 may be initiated during subsequent clock cycles.

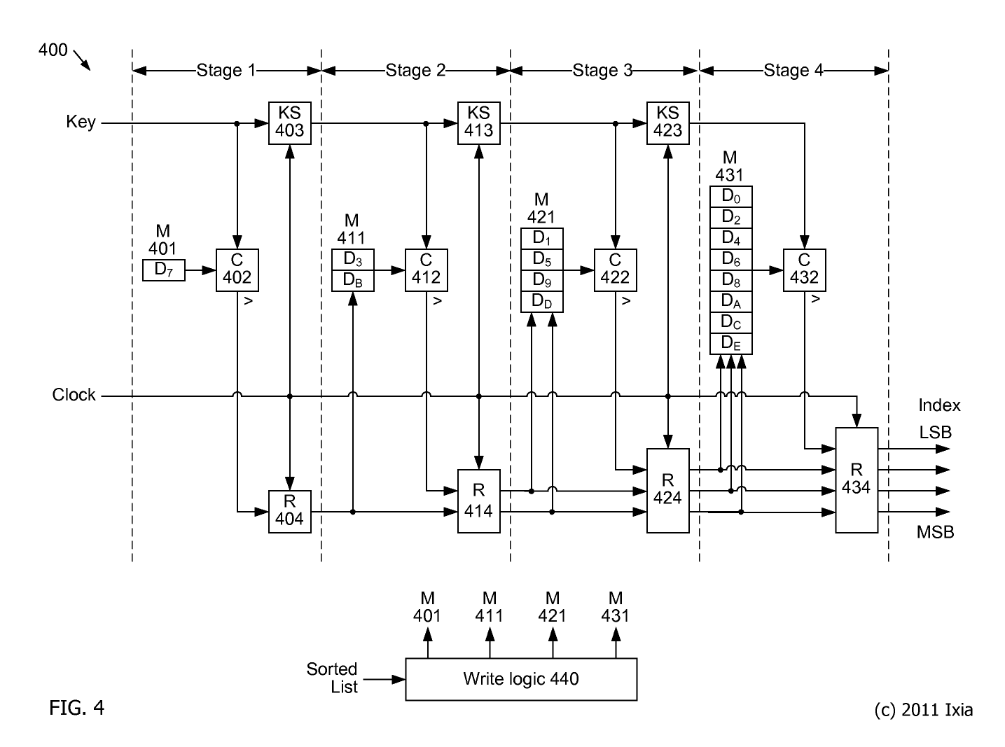

FIG. 4 is a block diagram of another embodiment of a pipeline binary search engine 400 to search a sixteen-value ordered list as shown in FIG. 1. The elements of the pipelined binary search engine 400 are generally the same as the corresponding elements of the pipelined binary search engine 200 of FIG. 2, except for the function of the comparators 402, 412, 422, 432. Descriptions of elements having identical functions will not be repeated. The result from each comparator 402, 412, 422, 432 is a single bit which is a logic zero when the key is less than or equal to the value read form the respective stage memory (401, 411, 421, 431), or logic one when the key is greater than the value read form the respective stage memory. The arrangement of the values from the ordered list in the memories 401, 411, 421, 431 is adjusted such that the index output from the pipeline binary search engine 400 is the same as the index output from the pipelined binary search engine 200.

For example, in the pipelined binary search engine 200, the stage 1 memory 401 holds the value D₈, which is the smallest value in the upper half of the ordered list 100. The result from the stage 1 comparator indicates if the key falls within the upper half (key greater than or equal to D₈) or lower half (key less than D₈) of the ordered list. In the pipelined binary search engine 400, the stage 1 memory 401 holds the value D₇, which is the largest value in the lower half of the ordered list 100. The result from the stage 1 comparator still indicates if the key falls within the upper half (key greater than D₇) or lower half (key less than or equal to D₇) of the ordered list. Thus the result from stage 1, and each subsequent stage, of the pipelined binary search engines 200 and 400 are the same.

Although not shown in FIG. 2 or FIG. 4, the outputs from the comparators with each stage of a pipelined binary search engine may be inverted, such that an output of logic one indicates that the key is less than, or less than or equal to, the value read from the respective stage memory. In this case, the index output from the pipelined binary search engine may indicate the location within an ordered list of the largest value that does not exceed the key value.

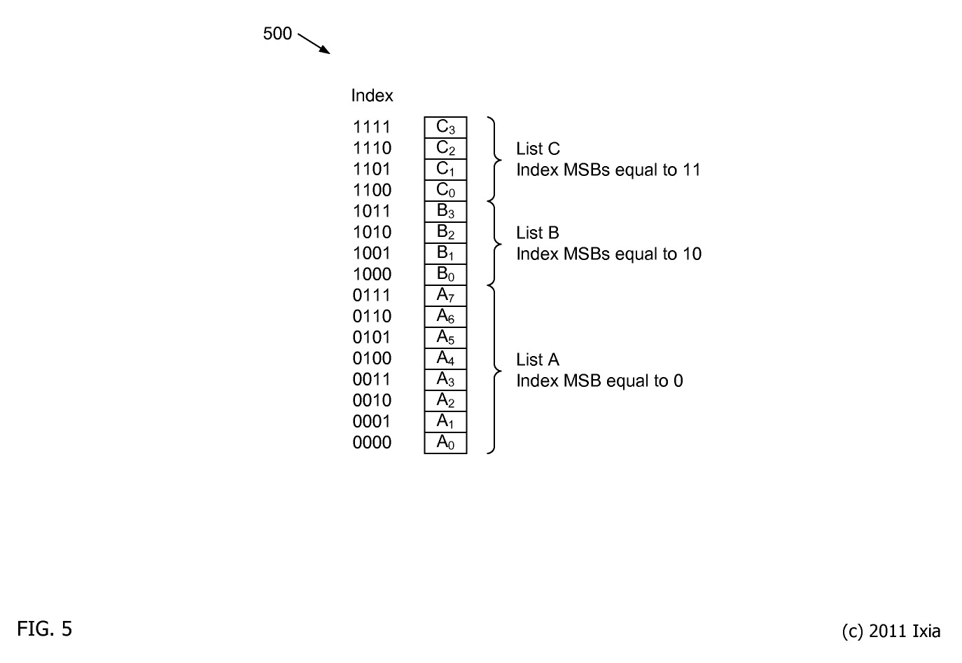

FIG. 5 is a graphical representation of an exemplary multi-parameter ordered list 500. The multi-parameter ordered list 500 is the juxtaposition of three ordered lists, identified as list A, list B, and list C. List A contains eight values and lists B and C each contain four values. The values within each of the lists A, B, C are ordered. A₀, B₀, and C₀ are the smallest values within the respective lists and A₇, B₃, and C₃ are the largest values within the respective lists. Each of the other values in the lists is larger than the preceding value and smaller than the succeeding value. The exemplary multi-parameter ordered list 500 was chosen for ease of description. A multi-parameter ordered list may contain more than three juxtaposed lists and substantially more than sixteen values.

A four-bit index may be used to identify the position of each value in the multi-parameter ordered list 500. It can be seen the most significant bit (MSB) of the index values for list A is zero, and the most significant bits of the index values for lists B and C are 10 and 11, respectively.

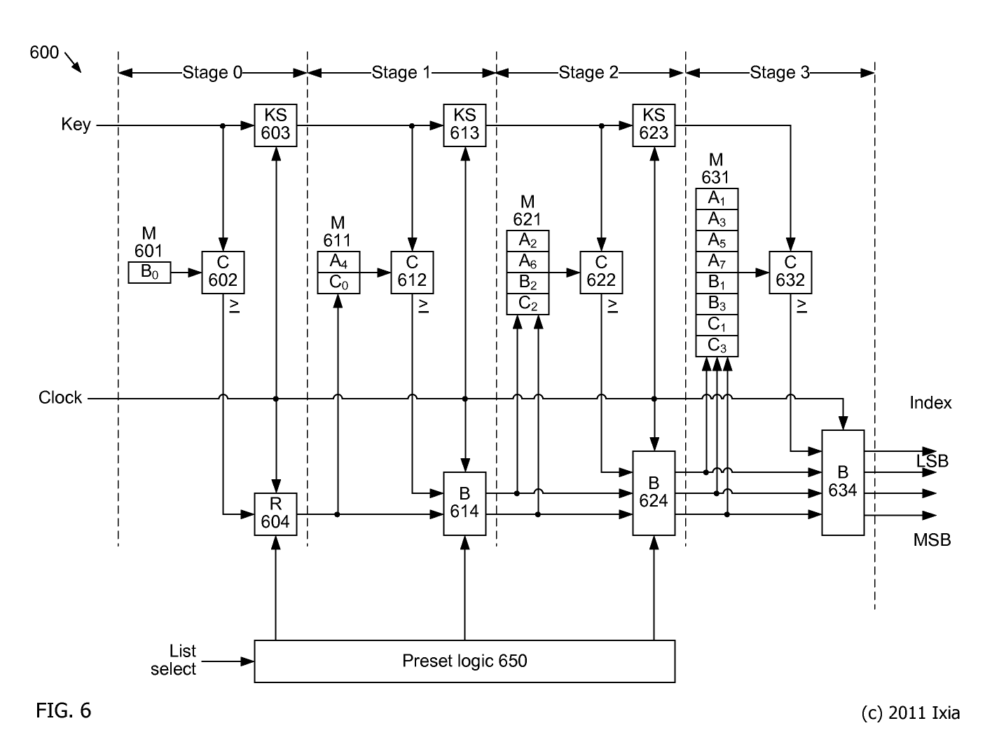

Referring now to FIG. 6, a pipeline binary search engine 600 may be configured to search the multi-parameter list 500 shown in FIG. 5. With exception of preset logic 650, each element of the pipelined binary search engine 600 has the same function as the corresponding element in the pipeline binary search 200 of FIG. 2. Descriptions of elements having the same function will not be repeated. Further the relative locations of the values of the ordered lists within the memories of the pipelined binary search engines 200 and 600 are the same. For example, the ninth value (D₈) of the ordered list 100 is stored in the stage 1 memory 201 of the pipelined binary search engine 200, and the ninth value (B₀) of the multi-parameter ordered list 500 is stored in the stage 1 memory 601 of the pipelined binary search engine 600.

The preset logic 650 receives list select data indicating which list within a multi-parameter ordered list is to be searched. For example, the list select data may include data indicating a number of most significant index bits that are predetermined and data indicating the values of the predetermined bits. Continuing the example of FIG. 5, to select list A the list select data may indicate that the MSB of the index is predetermined, and that the value of the predetermined MSB is 0. Similarly, to search list B or list C, the list select data may indicate that the two MSBs are predetermined and that the values of the two MSBs are 10 or 11, respectively. If the list select data indicated that no bits of the index are predetermined, the pipelined binary search engine 600 would function identically to the pipelined binary search engine 200, as previously described.

The preset logic 650 may use the list select data to override the results of comparisons made in the first stage or stages of the pipelined binary search engine 600. For example, to search list A, the preset logic 650 may force the result stored in the first stage result register 604 to be 0 regardless of the output of comparator 602. The preset logic may either set the result register 604 to 0 directly, or may force the output of the comparator 602 to 0 before the result is stored in the result register 604. Similarly, to search list B or list C, the preset logic 650 may force the result stored in the second stage result register 614 to be 10 or 11, respectively, regardless of the outputs of comparators 602 and 612. In this case, the actions (reading from the respective memories and performing the comparisons) within stage 1 and stage 2 may still be performed, although the results of those actions are subsequently overridden by the preset logic.

The pipelined binary search engine 600 can, with proper input of list select data, perform binary searches of different list configurations. Specifically, the pipelined binary search engine 600 can search a single 16-value ordered list, two 8-value ordered lists, four 4-value lists, eight 2-value lists or any combination of lists. The lists must be organized such that the index values for all of the elements in each list have the same most significant bits.

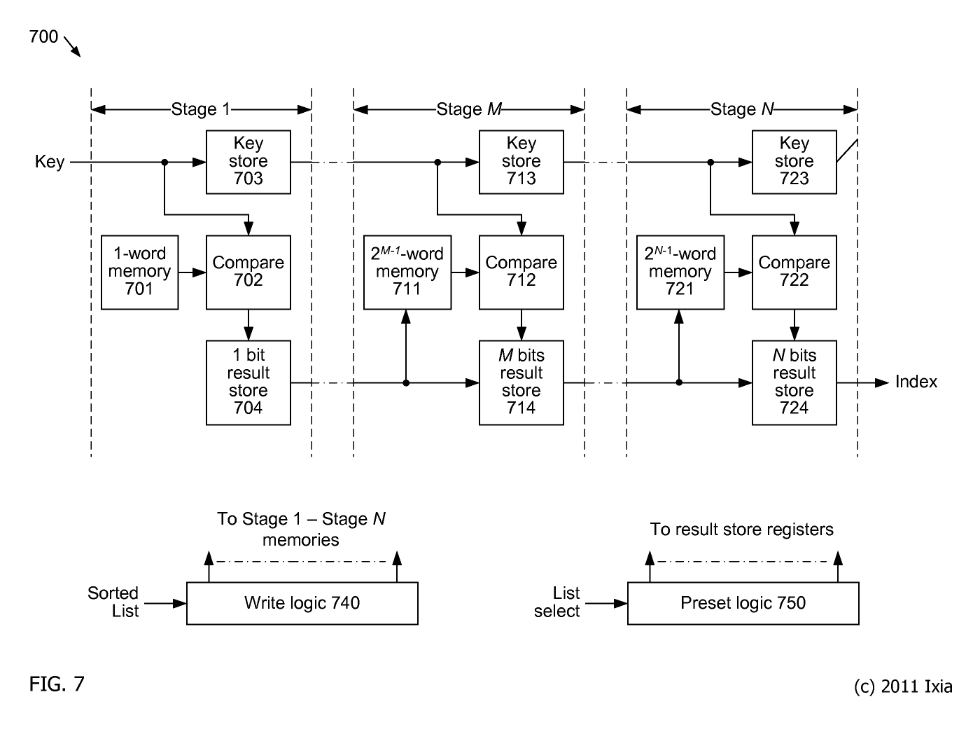

FIG. 7 is a block diagram of a generalized pipelined binary search engine 700 to search an ordered list or a multi-parameter ordered list having 2^{N} entries, where N is an integer greater than one. The pipelined binary search engine may have N stages, which may be numbered in sequence from 1 to N. Stage M, where M is an integer from 1 to N, may include a 2^{M-1}-word memory (701, 711, 721), a comparator (702, 712, 722) and an M-bit results store register (704, 714, 724).

The stage 1 memory 701 may store a single word. The stage 1 comparator 702 may compare the word stored in the stage 1 memory 701 with a key value. The comparators (712, 722) in subsequent stages may compare the key value with a word read from the corresponding memory based on the comparison results from previous stages. In each stage, the results from the respective comparator, along with results from any previous stages, may be stored in the respective results store register (704, 714, 724). Stages 1 to N−1 may include a key store register (703, 713) to store the key value for use by the subsequent stage. Stage N may optionally include a key storage register 723.

The comparison result output from the stage 1 comparator 702 may indicate if the key value falls within the upper half or the lower half of the ordered list being searched. To this end, value stored in the stage 1 memory may be one of the largest value in the lower half of the ordered list or the smallest value in the upper half of the ordered list, depending on the logic of the comparator 702. The comparison result at each subsequent stage may divide the portion of the ordered list being searched in half.

The pipelined binary search engine 700 may include write logic 740 to store the elements of an ordered list or multi-parameter ordered list in the appropriate memories (701, 711, 721). The pipelined binary search engine 700 may also include preset logic 750 to allow selection of a specific list within a multi-parameter ordered list by setting one or more most significant bits of the index value in accordance with list select data. The preset logic may set the one or more most significant bits by setting the contents of the results store registers within one or more stages of the pipelined binary search engine 700 independent of the results from the respective comparators.

It should be understood that the pipelined binary search engines 200, 400, 600 of FIGS. 2, 4, and 6 are specific embodiments of the generalized pipelined binary search engine 700 with N=4.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An apparatus for performing a binary search of an ordered list containing 2^{N} values, where N is an integer greater than one, the apparatus comprising:
a pipeline having N stages numbered 1 to N in sequence;
stage 1 including:
a stage 1 memory storing a single value from the ordered list,
a stage 1 comparator to compare a key to the value stored in the stage 1 memory, and
a stage 1 storage register to store a comparison result from the stage 1 comparator;
each subsequent stage comprising:
a stage M memory storing 2^{M-1} values from the ordered list, where M is the stage number from 2 to N;
a stage M comparator to compare the key to a value read from the stage M memory based on comparison results from previous stages in the pipeline; and
a stage M result storage register to store a comparison result from the stage M comparator and the comparison results from the previous stages in the pipeline.

2. The apparatus of claim 1, wherein
the comparison result from the stage 1 comparator indicates whether the key falls within a lower half or an upper half of the ordered list.

3. The apparatus of claim 2, wherein
the comparison result from the comparator within each stage of the pipeline subsequent to stage 1 divides the portion of the ordered list being searched in half.

4. The apparatus of claim 1, each stage from stage 1 to stage N−1 further comprising:
a respective key storage register to store the key for use by subsequent stages of the pipeline.

5. The apparatus of claim 4, wherein all of the result storage registers and the key store registers are responsive to a common clock.

6. The apparatus of claim 1, further comprising:
write logic to selectively store the values of the ordered list in the respective memories of the N stages.

7. The apparatus of claim 1, further comprising:
preset logic to select a portion of the ordered list in accordance with list select data.

8. The apparatus of claim 7, wherein the preset logic sets the content of at least the stage 1 result storage register independent of the output from the stage 1 comparator.

9. A machine readable storage medium containing data that, when used to configure a programmable device, configures the device to include a pipelined search engine for performing a binary search of an ordered list containing 2^{N} values, where N is an integer greater than one, the pipelined search engine comprising:
a pipeline having N stages numbered 1 to N in sequence;
stage 1 including:
a stage 1 memory storing a single value from the ordered list,
a stage 1 comparator to compare a key to the value stored in the stage 1 memory, and
a stage 1 storage register to store a comparison result from the stage 1 comparator;
each subsequent stage comprising:
a stage M memory storing 2^{M-1} values from the ordered list, where M is the stage number from 2 to N;
a stage M comparator to compare the key to a value read from the stage M memory based on comparison results from previous stages in the pipeline; and
a stage M result storage register to store a comparison result from the stage M comparator and the comparison results from the previous stages in the pipeline.

10. The machine readable storage medium of claim 9, wherein
the comparison result from the stage 1 comparator indicates whether the key falls within a lower half or an upper half of the ordered list.

11. The machine readable storage medium of claim 10, wherein
the comparison result from the comparator within each stage of the pipeline subsequent to stage 1 divides the portion of the ordered list being searched in half.

12. The machine readable storage medium of claim 9, each stage from stage 1 to stage N−1 further comprising:
a respective key storage register to store the key for use by subsequent stages of the pipeline.

13. The machine readable storage medium of claim 12, wherein all of the result storage registers and the key store registers are responsive to a common clock.

14. The machine readable storage medium of claim 9, the pipelined search engine further comprising:
write logic to selectively store the values of the ordered list in the respective memories of the N stages.

15. The machine readable storage medium of claim 9, the pipelined search engine further comprising:
preset logic to select a portion of the ordered list in accordance with list select data.

16. The machine readable storage medium of claim 15, wherein the preset logic sets the content of at least the stage 1 result storage register independent of the output from the stage 1 comparator.
